(19) United States
(12) Patent Application Publication
(10) Pub. No.: US 2010/0139236 A1
(43) Pub. Date: Jun. 10, 2010

(54) HARVESTING TOOL

(76) Inventors: Catherine Soucy, Terryville, CT (US); Rebecca Graham, Terryville, CT (US); Cynthia Graham, Terryville, CT (US)

Correspondence Address: L.C. Begin & Associates, PLLC, PMB 403, 510 Highland Avenue, Milford, MI, 48381, US

(21) Appl. No.: 12/635,512

(22) Filed: Dec. 10, 2009

Related U.S. Application Data
(60) Provisional application No. 61/121,269, filed on Dec. 10, 2008.

(51) Int. Cl. A01D 46/00

(52) U.S. Cl. 56/330

(57) ABSTRACT

One embodiment of a tool to aid in harvesting edible plant products may include a glove adapted to be worn on an individual's hand for protecting the hand against injuries while harvesting the plant products. The harvesting tool may also include a claw member extending from the glove, the claw member adapted for dislodging the plant products from a branch bearing the plant products. Further, the harvesting tool may include an attachment member adapted to be removably attached to an upper end portion of a pole for facilitating in maneuvering the plant. Moreover, the harvesting tool may include a gripping tool adapted to be carried by the individual for holding a receptacle underneath the plant products intended to be dislodged in order to collect the plant products in the receptacle.

### CROSS REFERENCE TO RELATED APPLICATION

This application claims the benefit of U.S. Provisional Application No. 61/121,269 filed on Dec. 10, 2008, the disclosure of which is incorporated by reference.

### FIELD OF THE INVENTION

The present disclosure generally relates to aids for harvesting or collecting an edible plant product from a plant bearing the product.

### BACKGROUND OF THE INVENTION

Many edible plant products grow on bushes or branches of trees which are not readily accessible to a person harvesting or gathering the products. For example, tree branches may be too high for a person to reach without aid, or branches may have thorns growing thereon. In one example, berries are typically collected or picked from berry trees and berry bushes by an individual with his/her bare hands. Collecting berries with bare hands includes several drawbacks. For example, some branches, bearing the berries, may have thorns which may scratch or prick the individual's hands while picking the berries. Further, sometime the branches may not be reached by the individual's hand, therefore in such situation the collection of the berries becomes a time consuming and cumbersome task.

### SUMMARY OF THE INVENTION

One embodiment of a harvesting aid or tool may include a glove adapted to be worn on an individual's hand for protecting the hand against injuries while picking berries or harvesting other edible plant products. The harvesting aid may also include a claw member extending from the glove, the claw member being adapted for dislodging the plant products from a branch bearing the plant products. Further, the harvesting aid may include an attachment member adapted to be removably attached to an upper end portion of a pole for facilitating in maneuvering a portion of a plant bearing the plant product. Moreover, the harvesting aid may include a gripping tool or pliers tool adapted to be carried by the individual for holding a receptacle underneath the plant product intended to be dislodged in order to collect the plant product in the receptacle.

### BRIEF DESCRIPTION OF THE DRAWINGS

The advantages and features of the present disclosure will become better understood with reference to the following detailed description and claims taken in conjunction with the accompanying drawing, in which:

FIG. 1 is a perspective view of one embodiment of a harvesting aid; and

FIGS. 2 and 3 are environments illustrating collection of berries using the harvesting aid of FIG. 1.

Like reference numerals refer to like parts throughout the description of several views of the drawings.

### DETAILED DESCRIPTION OF THE INVENTION

The exemplary embodiments described herein detail for illustrative purposes are subject to many variations in structure and design. It should be emphasized, however, that the present disclosure is not limited to a particular harvesting aid as shown and described. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting.

The terms, “first,” “second,” and the like, herein do not denote any order, elevation or importance, but rather are used to distinguish one element with another. Further, the terms, “a” and “an” herein do not denote a limitation of quantity, but rather denote the presence of at least one of the referenced item.

The present disclosure provides an apparatus for harvesting an edible plant product from a plant bearing the product. As used herein, the term “edible plant product” is understood to mean any nuts, berries, or other fruits or products that grow on bushes, trees, or other plants, wherein such plant products are either edible to humans and/or animals or may be used to produce products which are edible to humans and/or animals. As described below, one exemplary embodiment of the harvesting apparatus or product collecting assembly is directed to the picking or collection of berries from bushes and/or trees. However, it will appreciated that the various elements of the harvesting aid described herein may be adapted (according to the nature of the plant product to be harvested, the plant structure, and other factors) for harvesting edible plant products from a wide variety of plants.

In one particular embodiment, the harvesting aid is configured as a berry collecting assembly for use in collecting/picking berries from bushes or trees, bearing the berries. Specifically, the berry collecting assembly may enable in collecting/picking the berries in a safe, quick and convenient manner.

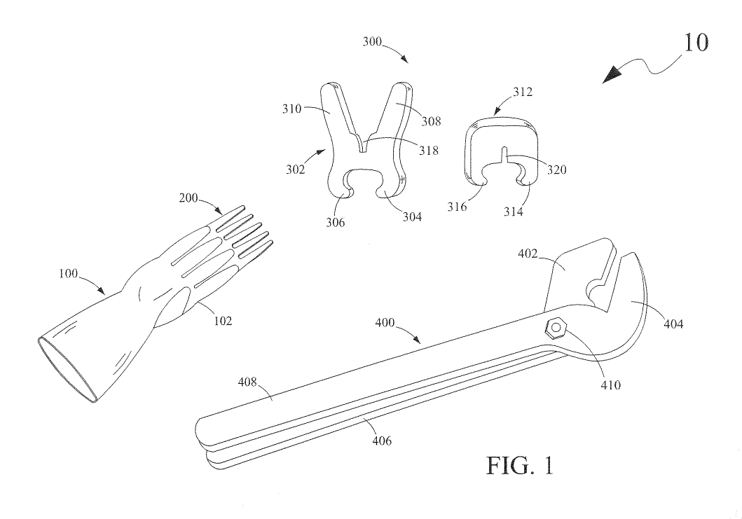

Referring to FIG. 1, a berry collecting assembly 10 may include a glove 100. The glove 100 may be worn on an individual's hand while picking berries. The glove 100 may be made of a scratch and prick resistant material. For example, the material may include but not limited to leather, rubber and plastic.

The berry collecting assembly 10 may also include a claw member 200 extending from a top portion 102 of the glove 100. Specifically, the claw member 200 may extend from the top portion 102, covering a back side of a palm of the individual's hand, of the glove 100. The claw member 200 may be attached to the top portion 102 by a suitable attachment means known in the art. Suitable examples of the attachment means may include, but are not limited to, glue, stitching, interlocking fitting engagement members, and the like. Further, the claw member 200 may be made of a tough and lightweight material, which may include but not limited to plastic and metal, such as aluminum.

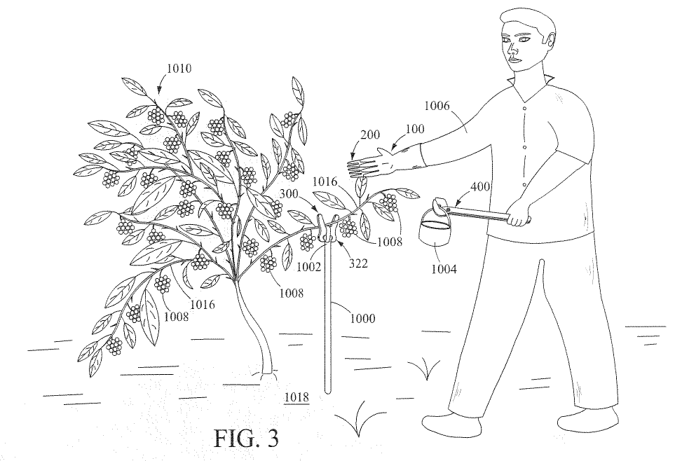

The berry collecting assembly 10 may further include an attachment member 300 adapted to be removably attached to a pole 1000, as shown in FIG. 3. Particularly, the attachment member 300 may be removably attached to an upper end portion 1002 of the pole 1000. Referring back to FIG. 1, the attachment member 300, shown in unassembled state, may include a first portion 302 having a first pair of curved brackets 304, 306 and a pair of straight brackets 308, 310. The pair of straight brackets 308, 310 may be configured to have a Y-shaped structure. Further, the attachment member 300 may also include a second portion 312 having a second pair of curved brackets 314, 316.

The second portion 312 may be adapted to fit onto the first portion 302. Specifically, the first portion 302 may include a first channel 318 configured between the pair of straight brackets 308, 310, and the second portion 312 may include a second channel 320 configured between the second pair of curved brackets 314, 316. Accordingly, the second portion 312 may be press fit onto the first portion 302 when the second channel 320 conform the first channel 318. Further, upon press fitting the first portion 302 and the second portion 312, the first pair of curved brackets 304, 306 and the second pair of curved brackets 314, 316 may configure a gripping structure 322 adapted to secure the upper end portion 1002 of the pole 1000, as shown in FIG. 3. The attachment member 300 may be made from one of plastic, rubber and hard cardboard.

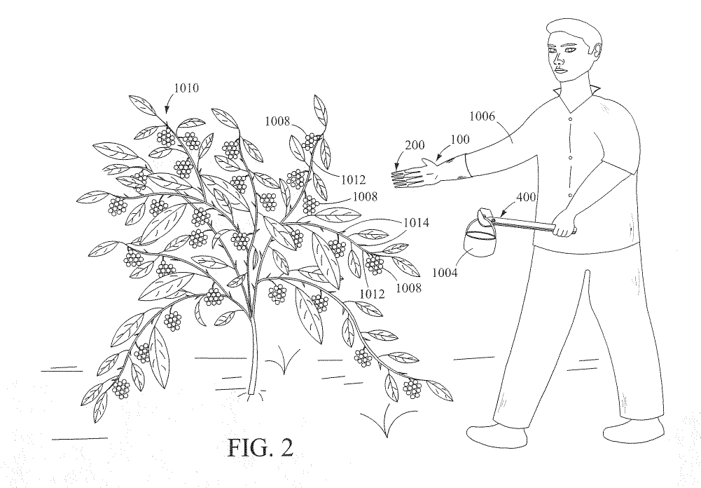

As shown in FIG. 1, the berry collecting assembly 10 may also include a gripping tool or pliers tool 400 adapted to carry a receptacle 1004, such as a bowl, as shown in FIGS. 2 and 3. The pliers tool 400 may include jaw portions 402, 404 capable of securing the bowl 1004 therebetween. The pliers tool 400 may also include handle portions 406, 408 which may be operated for allowing the jaw portions 402, 404 to attain an open position and a closed position. Further, the pliers tool 400 may also include a nut and bolt arrangement 410 for coupling the handle portions 406, 408 together. The pliers tool 400 may be made of plastic.

Referring now to FIG. 2, in use, the glove 100 may be worn on an individual's hand 1006 for protecting the hand 1006 against injuries while picking berries 1008 from a berry bush 1010. For example, some branches 1012 of the berry bush 1010 may have thorns 1014 which may scratch or prick bare hand of the individual's while picking the berries 1008. In such instance, the glove 100 enables in protecting the individual's hand 1006 from the thorns 1014. Therefore, the individual may conveniently pick the berries 1008 from the branches 1012, and thereafter may put the berries 1008 into the bowl 1004. Alternatively, the individual may use the claw member 200 for shaking the berries 1008 or the branches 1012 of the berries 1008 for dislodging the berries 1008 from the branches 1012. Simultaneously, the individual may hold the bowl 1004, underneath the berries 1008 indented to be dislodged, with the help of the pliers tool 400 in order to collect the berries 1008 in the bowl 1004. Specifically, the claw member 200 may be used for shaking ripe berries or branches, bearing the ripe berries, in order to dislodge the ripe berries for being collected in the bowl 1004.

Referring now to FIG. 3, the individual may use the attachment member 300, removably attached to the pole 1000, for collecting the berries 1008 from the berry bush 1010. For example, when branches 1016 of the berry bush 1010 is beyond the reach of the individual's hand 1006, and further requires the individual to bend his/her back in order to reach the berries 1008. In such instance, the attachment member 300 carried by the pole 1000 may facilitate in maneuvering the branches 1016 for bringing the branches 1016 closer to the individual and thereby providing easier accessibility to the berries 1008. Specifically, the pole 1000 may be rested on a ground surface 1018 such that the branch 1016 may be supported between the pair of straight brackets 308, 310 of the attachment member 300 for holding the branch 1016 at a suitable height which may allow the individual to comfortably reach the berries 1008. Accordingly, the individual may use the glove 100 for individually picking the berries 1008 and thereafter may put the berries 1008 into the bowl 1004. Otherwise, the individual may use the claw member 200 in order to dislodge the berries 1008 from the branch 1016, and may hold the bowl 1004 underneath the berries 1008 for collecting the berries 1008 in the bowl 1004.

Additionally, the attachment member 300 in conjunction with the pole 1000 may be used in collecting berries from branches of a berry tree (not shown) which are typically far from a ground surface and are beyond the reach of the individual's hands. In such instance, the attachment member 300 may facilitate in maneuvering the branches of the berry tree for bringing the branches closer to the individual and thereby allowing the individual to collect the berries from the berry tree. Otherwise, the attachment member 300 may be used in shaking the branches of the beery tree, in order to dislodge the berries from the branches. Further, the bowl 1004 may be held underneath the dislodged berries for collecting the berries in the bowl 1004.

Based on the foregoing description of the present disclosure, it will be apparent that a harvesting aid in accordance with the present invention as embodied in a berry collecting assembly, such as the berry collecting assembly 10, may be used for collecting berries in a safe, quick, and convenient manner. Specifically, a glove, such as the glove 100, of the berry collecting assembly may enable in protecting the individual's hand from scratches and pricking while picking the berries. Further, an attachment member, such as the attachment member 300, in conjunction with a pole may be used for reaching the berries beyond the reach of the individual's hands. It will also be appreciated that the elements of the harvesting aid described above may be adapted according to the needs of a particular application to enable harvesting or gathering of a wide variety of edible plant products which may be difficult or hazardous to reach.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. A berry collecting assembly comprising:
a glove adapted to be worn on an individual's hand for protecting the hand against injuries while picking berries;
a claw member extending from a top portion of the glove, the claw member adapted for dislodging the berries from a branch bearing the berries;
an attachment member, the attachment member adapted to be removably attached to an upper end portion of a pole for facilitating in maneuvering the branch; and
a pliers tool, the pliers tool adapted to be carried by the individual for holding a bowl underneath the berries intended to be dislodged in order to collect the berries in the bowl.

2. The berry collecting assembly of claim 1, wherein the attachment member comprises
a first portion having a first pair of curved brackets and a pair of straight brackets, the pair of straight brackets adapted to maneuver the branch for dislodging the berries from the branch; and
a second portion having a second pair of curved brackets,
wherein the second portion is adapted to fit onto the first portion for allowing the first pair of curved brackets and the second pair of curved brackets for configuring a gripping structure adapted to secure the upper end portion of the pole.

3. The berry collecting assembly of claim 1, wherein the glove is made from one of leather, rubber, and plastic.

4. The berry collecting assembly of claim 1, wherein the claw member is made from one of plastic and metal.

5. The berry collecting assembly of claim 1, wherein the attachment member is made from one of plastic, rubber and hard cardboard.

6. The berry collecting assembly of claim 1, wherein the pliers tool is made of plastic.

7. An apparatus for harvesting an edible plant product from a plant bearing the product, the apparatus comprising:
a glove adapted to be worn on an individual's hand for protecting the hand against injuries while harvesting the plant products; and
a claw member extending from the glove, the claw member being adapted for dislodging the plant products from the plant.

8. The apparatus of claim 7 further comprising an attachment member adapted to be removably attached to an upper end portion of a pole for facilitating in maneuvering of a portion of the plant.

9. The apparatus of claim 7 further comprising a gripping tool adapted to be carried by the individual for holding a receptacle underneath the plant product intended to be dislodged in order to collect the plant product in the receptacle.

10. A product collecting assembly comprising:
a glove adapted to be worn on an individual's hand for protecting the hand against injuries while collecting a product;
a claw member extending from a top portion of the glove, the claw member adapted for dislodging the product from a branch or vine bearing the product;
an attachment member, the attachment member adapted to be removably attached to an upper end portion of a pole for facilitating in maneuvering the branch or vine; and
a pliers tool, the pliers tool adapted to be carried by the individual for holding a bowl underneath the product intended to be dislodged in order to collect the product in the bowl.
